(19) United States
(12) Patent Application Publication
(10) Pub. No.: US 2017/0291829 A1
(43) Pub. Date: Oct. 12, 2017

(54) MEDIA, SYSTEMS, AND METHODS FOR WASTEWATER REGENERATION

(71) Applicant: AquaFresco, Inc., Somerville, MA (US)

(72) Inventors: Tsai-Ta Christopher Lai, Somerville, MA (US); Ting-Yun Sasha Huang, Somerville, MA (US); Alina Yu-Hsin Rwei, Somerville, MA (US)

(73) Assignee: AquaFresco, Inc., Somerville, MA (US)

(21) Appl. No.: 15/511,465

(22) PCT Filed: Sep. 17, 2015
(86) PCT No.: PCT/US15/50736

§ 371 Date: Mar. 15, 2017

Related U.S. Application Data
(60) Provisional application No. 62/052,295, filed on Sep. 18, 2014.

(51) Int. Cl. C02F 1/28; C02F 1/40; C09K 3/32; B01D 17/02; B01J 20/26; B01J 20/28; C02F 1/00; C02F 1/42

(52) U.S. Cl. CPC C02F 1/288; C02F 1/001; C02F 1/285; C02F 1/40; C02F 1/42; B01D 17/0202; B01J 20/262; B01J 20/261; B01J 20/28045; B01J 20/28016; B01J 20/28085; B01J 20/28004; C09K 3/32; C02F 2101/32

(57) ABSTRACT

A filtration device selectively removes hydrophobic waste from wastewater while leaving other water and surfactant components, which may then be recycled to a point of use. The wastewater treatment system may comprise a filtration unit and filtration media. The filtration unit may comprise a housing having an inlet in fluid communication with an outlet of a point of use and configured to receive a wastewater stream from the point of use for treatment, and an outlet in fluid communication with an inlet of the point of use and configured to deliver filtrate to the point of use. The filtration media may be positioned within the housing. The filtration media may comprise an oleophilic foam substrate and a hydrophobic coating on the oleophilic foam substrate. The filtration media may be configured to separate a hydrophobic component from the wastewater stream to produce filtrate comprising water and surfactant.

### CROSS-REFERENCE TO RELATED APPLICATION

This patent application claims the benefit of priority to U.S. Provisional Patent Application Ser. No. 62/052,295, filed on Sep. 18, 2014 and titled WASTEWATER REGENERATION DEVICE, which is hereby incorporated herein by reference in its entirety for all purposes.

### FIELD OF THE TECHNOLOGY

One or more aspects relate generally to wastewater regeneration, including filtration and recycling devices, systems, and methods. More particularly, one or more aspects involve the use of filtration processes to separate a hydrophobic waste component from water and surfactant components of a wastewater stream.

### SUMMARY

Aspects relate generally to various water treatment systems and methods in which a filtration device separates a hydrophobic waste component from a waste stream. In at least some aspects, water and other components, such as surfactants, may then be reused.

In accordance with one or more aspects, a wastewater treatment system is provided. The wastewater treatment system may comprise a filtration unit and filtration media. The filtration unit may comprise a housing having an inlet in fluid communication with an outlet of a point of use and configured to receive a wastewater stream from the point of use for treatment, and an outlet in fluid communication with an inlet of the point of use and configured to deliver filtrate to the point of use. The filtration media may be positioned within the housing. The filtration media may comprise an oleophilic foam substrate and a hydrophobic coating on the oleophilic foam substrate. The filtration media may be configured to separate a hydrophobic component from the wastewater stream to produce filtrate comprising water and surfactant.

In accordance with one or more aspects, the point of use may be one of a clothes laundering machine, dishwashing machine, car washing machine, or oil extraction operation. The point of use may be one of a petrochemical plant, a military wastewater treatment plant, a municipal water treatment plant, a drinking water purification system, an aerospace water treatment system, and a hotel wastewater recycling system. The surfactant may comprise a detergent. The system may further comprise a control system including at least one sensor configured to measure a parameter of the system, and a controller in communication with the at least one sensor and configured to produce an output signal to control an operation of the filtration unit in response to an input signal received from the at least one sensor. The filtration unit may further comprise a solids filter positioned in the housing upstream of the filtration media, and an ion exchange filter positioned in the housing downstream of the filtration media. The system may further comprise a source of make-up water to be mixed with the filtrate.

In accordance with one or more aspects, wastewater filtration media are provided. The wastewater filtration media may comprise a foam substrate comprising oleophilic polymer; and a hydrophobic coating on the foam substrate.

In accordance with one or more aspects, the foam substrate may have an average pore size between 400 μm and 1000 μm. The foam substrate may have an average pore size between 600 μm and 700 μm. The oleophilic polymer may be selected from the group consisting of: polyvinylchloride (PVC), polyethylene (PE), polyurethane (PU), polystyrene (PS), polylactic acid (PLA), acrylonitrile butadiene styrene (ABS), polycarbonate (PC), halogen-based polymer, fluorine-based polymer, chlorine-based polymer, silicone, nylon, acrylics, cellulose and composites thereof. The oleophilic polymer may be PU. The foam substrate may have an oil contact angle between 0° and 90°. The foam substrate may have an oil contact angle between 0° and 10°. The foam substrate may have a critical surface tension of between 20 mN/m and 70 mN/m. The foam substrate may have a critical surface tension of between 20 mN/m and 40 mN/m. The hydrophobic coating may have a water contact angle between 90° and 180°. The hydrophobic coating may be selected from the group consisting of: fluorine-based polymer, chlorine-based polymer, polyethylene glycol (PEG), zwitterionic polymer, sugar, protein lipids, graphene and carbon nanotubes. The hydrophobic coating may comprise polytetrafluoroethylene (PTFE). The hydrophobic coating may comprise deposited particles having an average diameter of 1 μm to 5 μm.

In accordance with one or more aspects, a method of separating a waste stream comprising water, surfactant, and hydrophobic material is provided. The method may comprise absorbing a majority of the hydrophobic material into an oleophilic-polymer-based foam filter; and rejecting a majority of the water and surfactant from absorption onto the foam filter to produce a filtrate stream comprising water and surfactant.

In accordance with one or more aspects, the waste stream may comprise greywater from a laundry, dishwashing, carwash, or petrochemical operation.

In accordance with one or more aspects, a method of filtering and recycling a waste stream is provided. The method may comprise passing a waste stream comprising water, surfactant, and hydrophobic material from a point of use through filtration media comprising an oleophilic-polymer-based foam substrate and a hydrophobic coating to produce a filtrate comprising water, surfactant, and a reduced hydrophobic material portion; and recycling the filtrate for re-use to the point of use.

In accordance with one or more aspects, the method may further comprise mixing the filtrate with a source of make-up water to produce a mixture prior to re-use at the point of use. The mixture may comprise 10% or less make-up water by volume. Passing the waste stream through filtration media may comprise pumping the waste stream through the filtration media. A single batch of filtrate may be repeatedly recycled to the point of use for a period of seven to eight months.

In accordance with one or more aspects, a method of regenerating saturated filtration media having an oleophilic-polymer-based foam substrate and a hydrophobic coating is provided. The method may comprise compressing the saturated filtration media to remove absorbed hydrophobic material and to produce regenerated filtration media.

In accordance with one or more aspects, the method may further comprise capturing and processing removed hydrophobic material. The method may further comprise replacing filtration media after five to ten cycles of compressing the saturated filtration media.

In accordance with one or more aspects, a method for manufacturing filtration media is provided. The method may comprise soaking an oleophilic foam substrate in a solution comprising organic solvent to produce a swollen foam; coating the swollen foam with hydrophobic particulate to produce a coated foam; and heating the coated foam to produce the filtration media.

In accordance with one or more aspects, the organic solvent may comprise dichloromethane or toluene. The oleophilic foam substrate may comprise PU. The hydrophobic particulate may comprise PTFE. The hydrophobic particulate may have an average particle diameter of 1 μm to 5 μm. Heating may be carried out at a temperature in the range of 80° C. to 150° C.

Still other aspects, embodiments, and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Accordingly, these and other objects, along with advantages and features of the present invention herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention and are not intended as a definition of the limits of the invention. For purposes of clarity, not every component may be labeled in every drawing. In the following description, various embodiments of the present invention are described with reference to the following drawings, in which:

FIG. 1 is a schematic representation of a conventional wastewater generation system;

FIG. 2 is a graphic representation of the potential reduction in water usage produced by methods and systems in accordance with one or more embodiments of the invention;

FIG. 3 is a schematic representation of a system for separating and recycling wastewater in accordance with one or more embodiments of the invention;

FIG. 4 is a schematic representation of a system for separating and recycling wastewater and making use of separated oils in accordance with one or more embodiments of the invention;

FIG. 5 is a schematic representation of a separation mechanism in accordance with one or more embodiments of the invention;

FIG. 6 is a schematic representation of properties of filtration media in accordance with one or more embodiments of the invention;

FIG. 7 is a graph showing parameters considered during filtration media selection in accordance with one or more embodiments of the invention;

FIG. 8 presents scanning electron microscope (SEM) images of coated and uncoated filtration media in accordance with one or more embodiments of the invention;

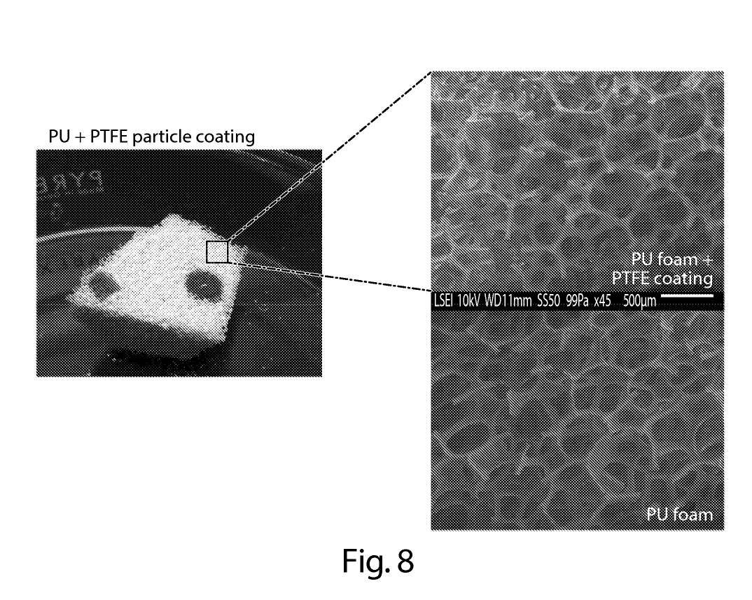

FIG. 9 is a graph showing the relationship between coating roughness and hydrophobicity in accordance with one or more embodiments of the invention;

FIG. 10 is a schematic representation of a method for coating filtration media in accordance with one or more embodiments of the invention;

FIG. 11 is a schematic representation of a filtration unit in accordance with one or more embodiments of the invention; and

FIG. 12 is a graph showing oil uptake rate over multiple regeneration cycles of a filter in accordance with one or more embodiments of the invention as discussed in an accompanying Example.

### DETAILED DESCRIPTION

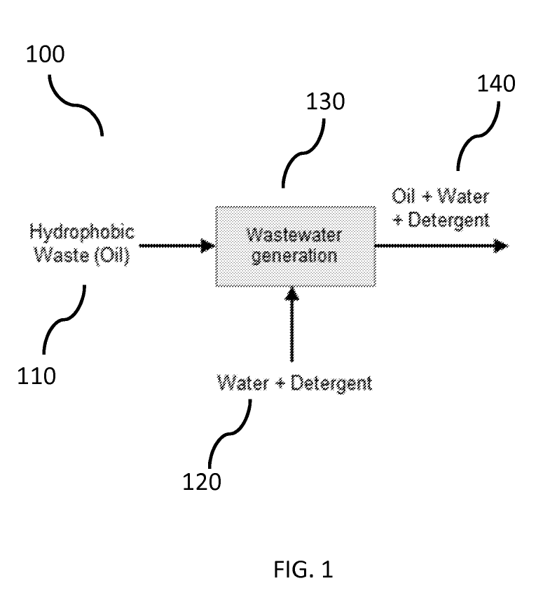

Water scarcity has become a challenge that impacts billions of people. The efficiency of water usage may be improved by facilitating the regeneration of wastewater. In laundry and dishwashing applications, for example, which account for more than 20% of domestic water consumption, a typical cleaning process utilizes significant amounts of water and detergent to remove an amount of hydrophobic waste (grease or stain) that comprises less than 1% of a resulting wastewater stream. FIG. 1 shows an example of such a prior art system 100. Fouled items 110 containing dirt and oil are mixed with a solution of water and detergent 120 at a point of use 130, such as a dishwasher or washing machine. A resulting wastewater stream 140, also referred to as grey water 140, is produced.

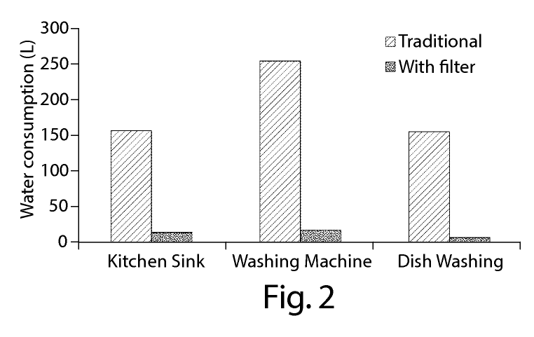

In accordance with one or more embodiments, the disclosed systems, methods, and devices may reduce total indoor household water consumption by at least 20% and significantly reduce the release of household detergent into the environment. Various embodiments may significantly reduce the amount of inputted water and detergent required to perform repeated water intensive cleaning activities such as washing clothes and dishes, as shown in FIG. 2. Water, surfactants, and/or heat may all be reused for enhanced efficiencies. Beneficially, the disclosed systems and methods are generally associated with lower energy requirements in comparison to conventional processes, such as that associated with application of heat and/or pressure. In at least some embodiments, disclosed devices, systems, and methods may be associated with up to or beyond about 95% savings on water and/or surfactant. The disclosed devices, systems, and methods are easy to install and scale to meet various loading requirements. The embodiments described herein are environmentally friendly. In embodiments relating specifically to laundry, the quality of resulting laundry in terms of look, feel, and texture is the same as that associated with conventional techniques with no discernable differences.

In accordance with one or more embodiments, a filtration device is provided that selectively removes hydrophobic compounds from a wastewater stream and allows for the recycling of the water and any surfactants, such as detergent, in the stream for reuse. For example, oily waste material may be selectively removed from washing machine wastewater and then the process water including detergent may be recycled for further use. In some embodiments, a phase separation filter may be implemented. The filter media may generally be characterized as water rejecting and oil absorbing. The filtration device may comprise regenerative oil-selective polymer filter media that may be used for greywater (or other process water) regeneration. In at least some embodiments, the filter media may be a coated foam.

In accordance with one or more embodiments, the disclosed devices, systems, and methods to recycle water may be implemented as a platform technology for wastewater treatment in various water treatment systems and processes, including, without limitation: hydraulic fracturing operations such as those associated with petrochemical industry, military wastewater treatment plant, municipal water treatment plants, drinking water purification systems, aerospace water treatment systems, hotel wastewater recycling systems such as those related to dishwashing and laundry, domestic water recycling systems related to including dishwashing and laundry, outsourced laundry services, commercial laundromats, and carwashes.

The disclosed filter media may be incorporated into a filtration unit or system that also includes additional filters, such as solid and salt filters. For example, pretreatment such as a lint trap may precede the disclosed filtration processes. Likewise, post-treatment such as an ion exchange operation may follow subsequent to the disclosed filtration processes. In various embodiments, pre- and/or post-treatment unit operations may be included in the housing with the filter media or separate in fluid communication therewith. The filtration unit may enable complete or near complete regeneration of wastewater. In the case of laundry and dishwashing, with the disclosed technology, it is estimated that a single batch of water and detergent can be used for repeated cleaning operations up to about seven or eight months. In this particular example, the disclosed filtration units may save more than 20% of indoor water consumption and more than 1 kg of detergent per month per person. The advantages of the disclosed filtration unit include, without limitation, that it is highly oil selective, regenerable, cheap, scalable and easy to implement. It has wide applications for wastewater regeneration and water purification in fields including but not limited to military, commercial laundry, hotel and restaurant, aerospace, food processing, carwash, petrochemical and urban water treatment.

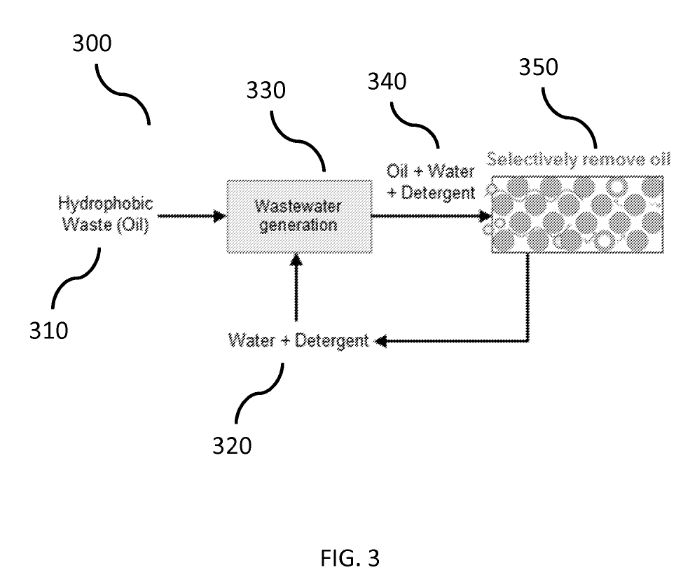

FIG. 3 presents a schematic of a system for greywater regeneration 300, according to one or more embodiments. Soiled items containing hydrophobic waste 310 are cleaned or treated with a source of water and detergent or other surfactant 320 at a point of use 330. The greywater (or wastewater) 340 is generated from the point of use 330 which may comprise household and industrial processes including but not limited to laundry, dishwashing, carwash, mining, food processing, industrial cleaning, petrochemical processing and municipal wastewater treatment. The wastewater 340 comprises various hydrophobic compounds (e.g. human body waste, cooking oil, gasoline, grease and engine oil), hydrophilic chemicals (e.g. salts, sugars, alcohols), surfactant (e.g., detergent or other application specific surfactant), and solids (e.g., dirt, particle suspension, and lint). The type of surfactants present in the wastewater depends on the particular application. Potential anionic surfactants include, without limitation: sodium dodecyl sulfate (SDS), dioctyl sodium sulfosuccinate, perfluorooctanesulfonate and perfluorooctanoate. Cationic surfactants include, without limitation: octenidine dihydrochloride, cetylpyridinium chloride, dimethyldioctadecylammonium chloride. Zwitterionic surfactants include, without limitation: cocamidopropyl hydroxysultaine, cocamidopropyl betaine and phosphatidylcholine. Nonionic surfactants include, without limitation: octaethylene glycol monododecyl ether, decyl glucoside and glyceryl laurate.

A foam-based filter 350 removes hydrophobic compounds from the process wastewater while allowing for further use of the remaining water and surfactant which is recycled as stream 320. The filter media may be specifically tailored based on the composition of various wastewater streams to be processed.

The disclosed filter media enables the recycling and reuse of wastewater within a semi-closed loop process. Wastewater, primarily comprising water, detergent (or some other surfactant), and hydrophobic waste, passes through the selective filter entrapping hydrophobic waste and releasing detergent and hydrophilic compounds as filtrate. The filtrate can then be recycled for subsequent rounds of processes that utilize the mixture of surfactants and water. Such processes include but are not limited to laundry, car washing, food processing, and petrochemical processes. When recycling the filtered aqueous mixture to another round of usage such as cleaning or laundry, water and/or detergent and/or other chemicals such as bleach may be added to replenish the loss of, or otherwise replace, any portion of such compounds during the recycling process for the lifetime of the filter. In laundry applications, for example, an amount of make-up water may be determined by the amount of water used in the rinsing cycle. Fresh rinse water may be used as make-up water to limit small molecules accumulation in the recycle water. Therefore, a purge stream (i.e. water drained from a storage tank) may be set to correlate or match an amount of rinse water added in some embodiments. Some water may therefore be purged from the semi-closed loop process and replaced with fresh make-up water such as that used in a rinse cycle. Likewise, detergent and/or other chemicals may be supplemented during recycle. The amount of these compounds may be monitored to facilitate the process. In some embodiments, the additions comprise 10% or less of the total amount of these components in the recycled stream. In some embodiments, the additions comprise 5% or less of the total amount of these components in the recycled stream. In embodiments where replenishment via supplement of one or more components takes place the process may be described as a semi-closed loop process.

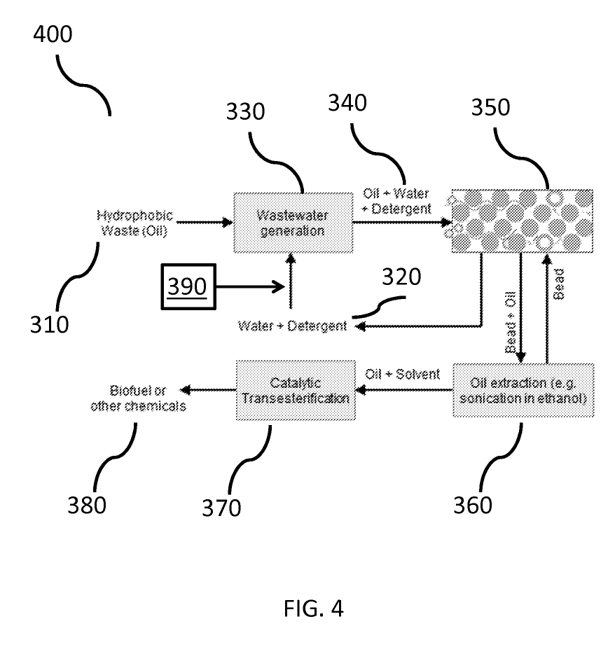

FIG. 4 presents a schematic of a system 400 according to one or more embodiments, in which the captured hydrophobic waste 360 is collected and used as biofuel or other energy sources 380 after separation with or without further chemical processing 370 and in which a source of make-up water 390 is also provided. According to some embodiments, foam media 350 is taken out directly from the housing after saturation. Hydrophobic waste, or retentate, may then be extracted from the media. The media, for example, may be compressed in a press system 360 to release the waste oils for further processing. The regenerated media is packed back into the filtration unit housing for future filtration processes. In other embodiments, the filtration media may be regenerated in place within the filter unit.

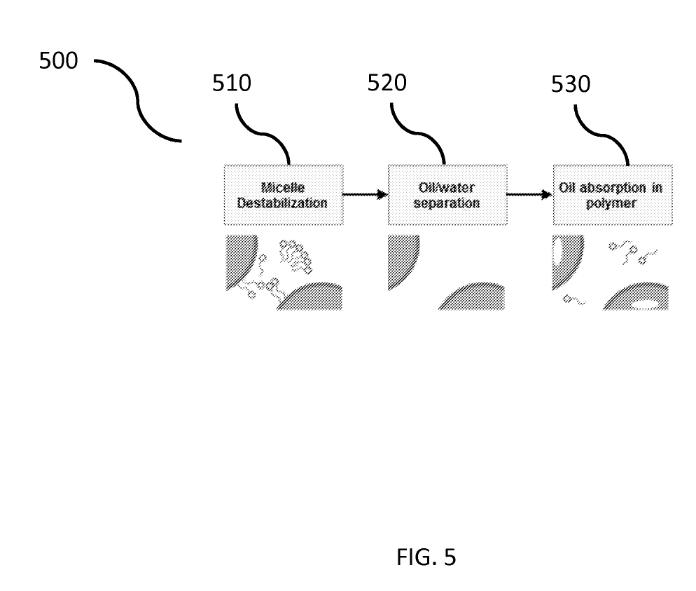

As shown in FIG. 5, during a filtration process 500, the hydrophobic waste is captured and temporarily stored inside the filtration media. In the example of laundering, oil and grease are removed from clothes during a cleaning step 510 by adding detergent and forming micelles or oil droplets that are semi-stabilized by the detergent in aqueous solution. As the detergent and waste move into the filter media, the oil and grease are separated from the aqueous phase during a separation step 520 and absorbed onto the filter media during an absorption step 530. The polarity of the waste and the filter media are aligned such that the hydrophobic waste has a greater affinity for the filter media compared with the aqueous phase. The media therefore capture and temporarily store the waste. Meanwhile water and detergent (which is generally categorized as amphiphilic, with part of the structure hydrophilic and part of it hydrophobic) as well as other hydrophilic compounds pass through the filter to form the filtrate.

Both hydrophobicity and oleophilicity are desired properties of the filter media. In some embodiments, the filter media may be a foam or other structure. In at least some embodiments, the filter media may be made of a polymer. However, polymers that are highly hydrophobic are often oleophobic as well. In accordance with one or more embodiments, this obstacle may be overcome by combining the two properties through using an oleophilic base foam coated with a hydrophobic (water-rejecting) particle layer.

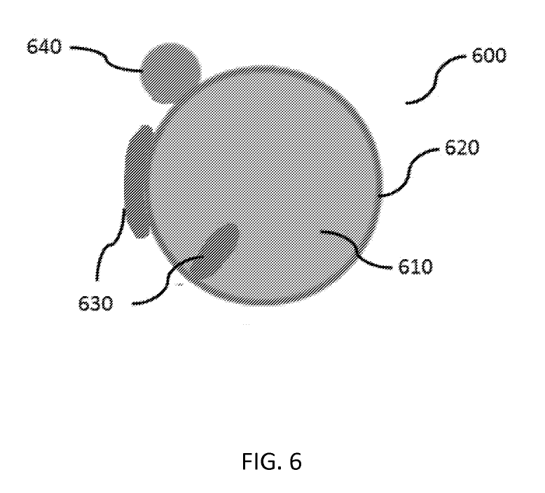

According to one or more embodiments, as shown in FIG. 6 the filter media 600 comprise a foam substrate 610 covered with a coating 620. The foam substrate 610, or base, may be formed from one or more types of oleophilic polymer. The coating 620 may be formed by one or more hydrophilic compounds. As shown in FIG. 6, the coating 620 rejects water 640 (shown having a high contact angle with the surface), while the foam substrate absorbs hydrophobic waste 630 (shown having a low contact angle).

According to one or more embodiments, the main properties of the filtration media are hydrophobicity, oleophilicity and pore size. Hydrophobicity can be measured by the water contact angle of the foam material. A water contact angle between 90° and 180° is considered hydrophobic, which is the contact angle according to one or more preferred embodiments. According to some embodiments, a contact angle between 70° and 90° is also acceptable. Oleophilicity can be determined by the oil contact angle of the base foam material. According to one or more embodiments the contact angle is between 0° and 90°. According to preferred embodiments the contact angle is less than 10° and approaching 0°.

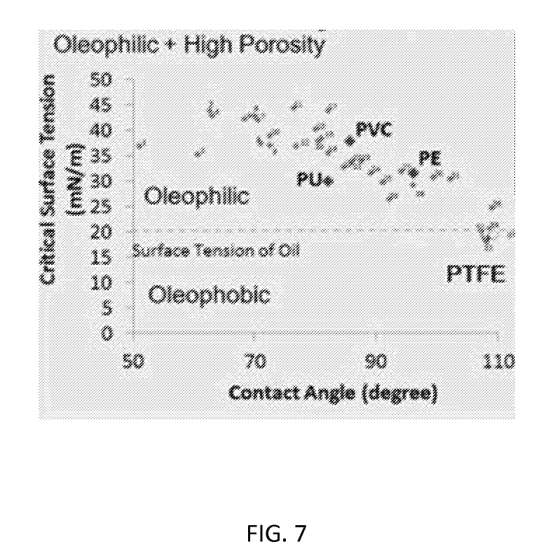

Oleophilicity can also be determined by the critical surface tension of the polymer material. Only when the critical surface tension is above the surface tension of a liquid will the liquid wet the surface. In this design, the critical surface tension of the filter media is desired to be above oil and below water such that it will absorb the oil phase and be less favorable to hydrophilic materials. The critical surface tension of the polymer exceeds that of oil (which is about 20 mN/m) to achieve oleophilicity. According to some embodiments the critical surface tension of the filter material is between 20 mN/m and 70 mN/m, preferably between 20 mN/m and 40 mN/m. Examples of the critical surface tensions of different materials are provided in FIG. 7.

In addition to being selected for oleophilic properties, the substrate polymer is selected based, at least in part, on its oil capacity, namely the amount of oil that can be captured per gram of the polymer in equilibrium. The parameters affecting the oil capacity include the surface energy of the polymer and the porosity of the foam medium. The definition of surface energy follows the equation: W=γA, where W is the interfacial energy or surface energy, γ is surface tension between the two substrates, and A is the surface area. The relationship between γ and critical surface tension (γₛ) is as follows: γ=(γ_{L}^{1/2}−γₛ^{1/2}) where γ_{L} is the liquid surface tension. The most favorable state in the system is one in which interfacial energy has been minimized. Thus, the base material of the filter should have favorable properties, such as a lower spreading parameter with water than with the waste, so that the waste components prefer to penetrate and stay inside the filter media thereby minimizing their interaction or interfacial energy with water.

The spreading parameter is related to surface tension and thus the interfacial energy according to the following equation: S=γₛ−(γ_{L}+γ), where S is the spreading parameter, γₛ is the critical surface tension, γ_{L} is the liquid surface tension, and γ is the surface tension between the liquid and the solid. According to certain embodiments, S has a positive value between the filter media and oil, and a negative value between the filter media and water.

The pore size of the foam is optimized for high oil uptake capacity. Pore size may be determined through, for example, analysis of SEM imagery. A high capacity for holding oil is another beneficial feature of the disclosed foam filter media. In addition to the thermodynamic properties of the filter material, the pore size of the filter is important. Pore sizes above 600 μm have demonstrated high oil capacity. According to one or more embodiments, an average pore size is in the range of 400 μm to 1000 μm. According to one or more preferred embodiments an average pore size is in the range of 600 μm to 700 μm.

In some preferred embodiments, material for the foam substrate includes, without limitation: polyvinylchloride (PVC), polyethylene (PE), polyurethane (PU), polystyrene (PS), polylactic acid (PLA), acrylonitrile butadiene styrene (ABS), polycarbonate (PC), fluorine/chlorine based polymer, silicone, nylon, acrylics, cellulose and the composites of these materials. The material may be polymeric or non-polymeric. The foam substrate may comprise one or more separate pieces of foam. Alternatively, the foam substrate may comprise a plurality of packed foam pieces. According to one or more embodiments, the foam substrate comprises urethane foam commercially available under the brand name FROST KING® from Thermwell Product Co., Inc.

In accordance with one or more embodiments, filter media is formed by extruding a polymer material mixed with foaming agents under high temperature. Upon decrease of pressure and temperature, foams are formed.

Additional surface modification of the foam, through the application of a coating onto the foam substrate, improves the selectivity of the filter media. In particular, a water-rejection coating is applied to enhance the efficiency of hydrophobic waste removal. The coating provides a selection barrier (water rejection and oil absorption) that increases the efficiency of waste removal, when treating the surfactant-containing wastewater.

The coating may comprise a particle coating. The coating material is selected from materials having a high water contact angle, which serves as a measure of hydrophobicity. The coating may be formed using chemicals including but not limited to fluorine/chlorine-based polymer, polyethylene glycol (PEG), zwitterionic polymer, sugar, protein and lipids. Inorganic compounds such as graphene or carbon nanotubes have shown to work as well.

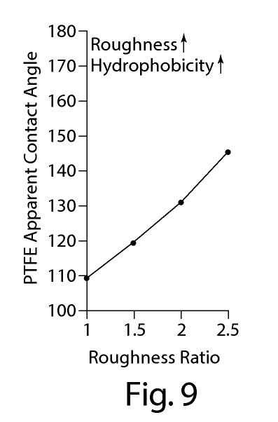

Physical properties of the coating, for example, the roughness of the coating, also contribute to its efficacy in rejecting water and surfactant. The particle size of the coating determines the roughness of the microscopic surface which effects the rejection of the aqueous phase. The roughness of the coated foam fibers enhances the hydrophobic properties of the filter media. As shown through the SEM images of FIG. 9, the introduction of a coating increases the roughness of the surface of the foam in comparison to the base polymer without the coating. A desired roughness may be achieved by controlling the size of the particles deposited to form the coating. According to one or more embodiments, the deposited coating particles have a diameter of 1 μm to 5 μm, with the lower diameter being more preferable. Increased surface roughness enhances hydrophobicity as show in the graph of FIG. 9 and as demonstrated through various models, including the Wenzel Model and the Cassie-Baxter Model. The Wenzel Model, for example, describes how roughness increases the water contact angle by the following equation (1):

cos θ*=r cos θ

where θ* is the observed contact angle, r is the roughness ratio (the ratio of the actual area to the apparent area), and θ is the Young contact angle. Equation (1) demonstrates the relationship between roughness and contact angle, showing that as the roughness increases so does the observed contact angle, which is a measure of hydrophobicity.

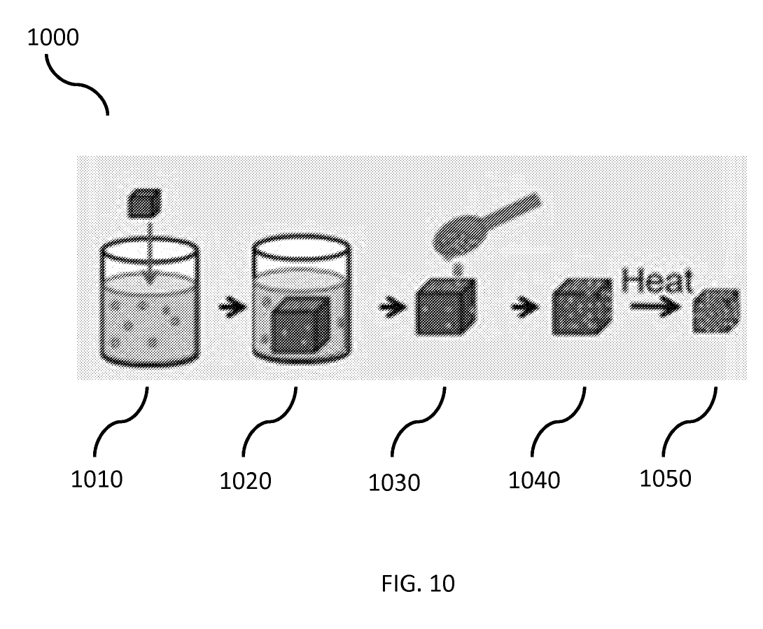

According to one or more embodiments, a method 1000 for coating the foam is provided, as shown in FIG. 10. According to one or more embodiments, a step 1010 in the coating method may comprise immersing the base foam in organic solvents that have a low interaction parameter (high affinity) with the foam material, such as dichloromethane or toluene. The foam swells while immersed, during step 1020, which causes an increase in the pore size of the foam and in the tension of the foam fibers. During step 1030, particles up to 5 μm in diameter made up of fluorinated polymers are scattered and rubbed onto the wetted foam. The scattering and rubbing proceeds until all sides are uniformly coated with the particles. The foam is then treated with heat between 80° C.-150° C. to vaporize the organic solvent during step 1040. Heating causes the foam to shrink to its original size during step 1050 and the coated foam is produced.

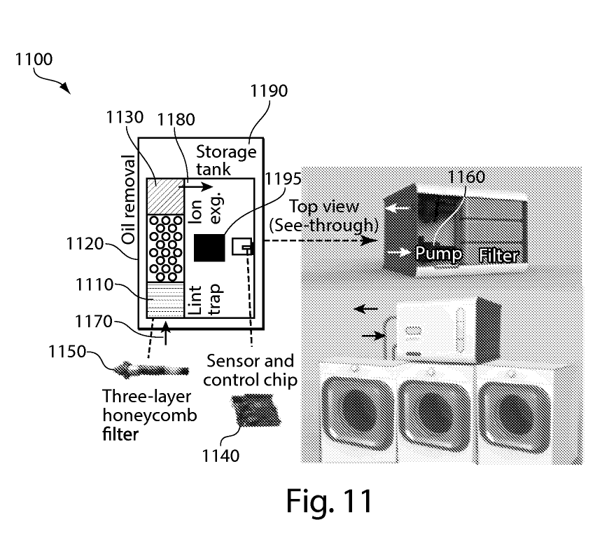

According to one or more embodiments, as shown in FIG. 11, a filtration unit 1100 comprising the filtration media 1120 is provided. The unit 1100 comprises a housing 1150 that includes an inlet 1170 that directs the influent to the filter media 1120. Additional optional filters are included in unit 1100. These filters include a lint filter 1110, or other solids-removing filter, upstream of the filtration media 1120, and an ion exchange filter 1130, downstream of filtration media 1120, to remove remaining ionic species such as salts from the water stream for softening. These filters may be positioned in series to remove lint, hydrophobic compound, and hydrophilic compound. A pump 1160 within the unit 1100 (or, alternatively, positioned outside of the unit 1100) controls the flow rate of liquid through the unit 1100. For a 0.1-0.5 L lab scale system, the flow rate is about 5-10 mL per minute. The residence time of the wastewater inside the filter is on the order of 10 minutes. Energy consumption is mainly from fluid transportation (pumping). Consumption generally scales with the size of the system. With every kilogram of water transported, an estimated 5-10 joules will be consumed.

A water storage tank 1190 and a waste collection tank 1195 are also associated with the filtration unit 1100. The water outlet 1190 is fluidly connected to the filter inlet 1170. The ion exchange filter 1130 is purchased from existing commercial suppliers, such as the deionization resin with functional structure of Cation, R⁻SO₃⁻H⁺ and Anion, R₄N⁺OH⁻. The lint trap 1110 is purchased commercially as well.

The outlet of the filtration unit is connected to the inlet of a point of use, for example, a washing machine, to allow the water and detergent to be used again. The filter will be regenerated occasionally based on the monitoring and control system 1140. The system 1140 measures such parameters as turbidity, conductivity, etc. The monitoring and control system 1140 may be used to automate any or all of the filtration steps, including without limitation: water inflow from the laundry machine, flow rate through the filter, amount of water sanitized and stored in the storage tank, amount of water pumped back to the washer for new laundry cycles, amount of water discharged and replaced, etc. Filter regeneration may also be automated. The control system may include one or more sensors configured to measure a parameter of the system (such as the parameters discussed above), and a controller in communication with the sensor and configured to produce an output signal to control an operation of the filtration unit (such as the operations discussed above) in response to an input signal received from the sensor.

After reaching capacity, the filter may be regenerated and returned to use. According to one or more embodiments regeneration incorporates a physical compression step for waste extraction. Physical compression applies a high force to the foam such that the foam will temporarily deform and shrink in volume. Physical compression may be accomplished through use of a press. In smaller applications, such as household applications, the press may be, for example, a syringe press. In larger applications, an industrial scale filter press may be used. As the main filtration mechanism for the foam is absorption, by physically compressing the foam, the loosely bounded hydrophobic waste compound will be released from the foam due to deformation from the applied pressure. The filter may then be returned to use. The useful life of the filter ranges from 5 to 10 compression/regeneration cycles. Other techniques for regenerating filtration media include liquid extraction, pressured air, and draw vacuum.

According to one or more embodiments, the resulting hydrophobic waste removed from the filter may be further processed into useful products such as biodiesel or ethanol. The processing may take place on site or the concentrated waste products and/or spent filtration media may be shipped elsewhere for treatment under a service contract. Alternatively, the waste may be captured with clay or like material and disposed as solid waste.

In accordance with one or more embodiments, an existing point of use may be retrofitted to incorporate a wastewater filtration and recycle technique as described herein for efficiency. A filtration unit may be provided. A waste outlet associated with the point of use can be fluidly connected to an inlet of the filtration unit. An outlet of the filtration unit can be fluidly connected to an inlet of the point of use. Alternatively, a point of use system may be engineered to incorporate a filtration and recycle approach as discussed herein, as may be implemented by an original equipment manufacturer.

The function and advantages of these and other embodiments will be more fully understood from the following example. This example is intended to be illustrative in nature and is not considered to be limiting the scope of the invention.

### EXAMPLES

### Example 1

Testing was performed on filtration media having a foam substrate comprising polyurethane (PU) and a particle coating (average particle size ˜1 μm) comprising polytetrafluoroethylene (PTFE).

The process for coating followed steps similar to those described in reference to FIG. 10. Dichloromethane was used as the solvent. The coated foams were heated at 100° C. to remove organic solvent.

1 L of synthesized laundry wastewater was prepared with 1% by vol. vegetable oil and 1M of sodium dodecyl sulfate (SDS). The oil phase was dyed blue for visual examination. The wastewater was stirred at a rate of 300 rpm with a magnetic stir bar, creating a uniform emulsion. The wastewater was then pumped by a peristaltic pump to the filter media. The filter was housed in a glass cylinder (with a diameter around 2 cm, length of 8 cm) packed with four filter foams. The foams filled up the cylinder space completely. The filtrate was collected at the outlet of the filter and tested with conductivity by a conductivity meter and oil content by an IR spectrometer. As the filter foams reached saturation, which was when the filtrate's color became blue, these foams were taken out from the filter and compressed inside a syringe for regeneration.

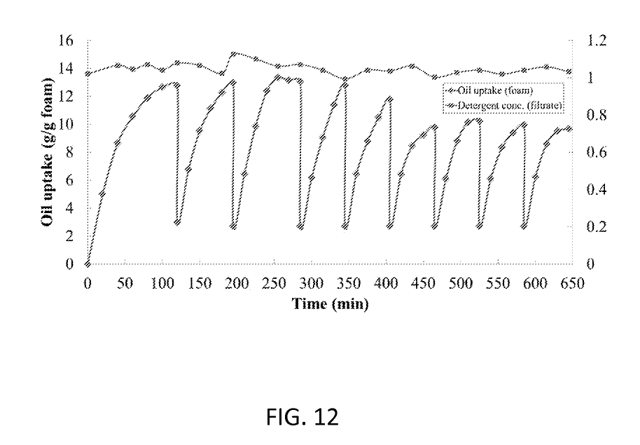

The testing results are shown in FIG. 12. The foam demonstrated an initial high rate of oil absorption, and as the foam reached saturation, the rate of absorption slowed down. The maximum oil capacity of the foams in the first cycle was about 12 g/g foam; while the detergent concentration remained constant throughout the filtration process. This indicates that, as desired, the detergent was not removed by the foam. After compressing the oil from the saturated foams, the polymer foams regained part of their oil absorbing capability—about 70% of the foam oil capacity was regenerated in the second cycle. The oil capacity deteriorated upon repetitive filtration-regeneration cycles. At the 10th cycle, the foam structure started to break down and coating particles were detached from the polymer and started to agglomerate inside the filter vessel.

The testing demonstrated both that the filter could successfully separate hydrophobic waste components from a surfactant/water mixture, and that the filter media could be regenerated over a number of cycles and returned to beneficial use.

### Example 2

Waste stream samples from a commercial laundering service were collected, filtered, and analyzed to determine the effectiveness of the disclosed filtration media on a waste stream produced under real conditions. Turbidity measurements were taken with light scattering instruments of both the raw wastewater and the filtrate. The improved transparency of the filtrate indicates that the disclosed filtration media function effectively under real world conditions.

50 mL samples of wastewater were pumped through the solid filter to remove excess solids then pumped through filtration media at a flow rate of 5 mL/min. The residence time in the filtration media was approximately three minutes.

1 mL samples of the filtrate were then tested for turbidity with the results compared to the raw sample wastewater. The transparency of the sample increased from 0 to 100 after filtration, indicating that all waste components were removed.

The retentate captured by the filtration media was also tested and it was determined that no detergent was inadvertently captured by the filtration media. The protocol for this testing was as follows. The foam was compressed to remove retentate. The liquid retentate was then placed in a solution having an equal amount of toluene by volume. The solution was vigorously mixed. The toluene portion was removed and sonicated. Remaining detergent is known to precipitate in the toluene phase as happened in a control group, no precipitation formed from the liquid inside the foam filter, indicating that the no detergent was captured by the filtration media, and that the detergent remained in the filtrate.

The composition of the raw waste water included the following: water, detergents, lint, solid particles, and hydrophobic oil droplets. The composition of the filtrate included water and detergents.

Having now described some illustrative embodiments of the invention, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives.

Furthermore, those skilled in the art should appreciate that the parameters and configurations described herein are exemplary and that actual parameters and/or configurations will depend on the specific application in which the systems and techniques of the invention are used. Those skilled in the art should also recognize or be able to ascertain, using no more than routine experimentation, equivalents to the specific embodiments of the invention. It is, therefore, to be understood that the embodiments described herein are presented by way of example only and that, within the scope of any appended claims and equivalents thereto; the invention may be practiced other than as specifically described.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish claim elements.

What is claimed is:

1. A wastewater treatment system, comprising:
a filtration unit, comprising:
a housing having an inlet in fluid communication with an outlet of a point of use and configured to receive a wastewater stream from the point of use for treatment, and an outlet in fluid communication with an inlet of the point of use and configured to deliver filtrate to the point of use; and
filtration media positioned within the housing, the filtration media comprising an oleophilic foam substrate and a hydrophobic coating on the oleophilic foam substrate, the filtration media configured to separate a hydrophobic component from the wastewater stream to produce filtrate comprising water and surfactant.

2. The system of claim 1, wherein the point of use is one of a clothes laundering machine, dishwashing machine, a car washing machine, a petrochemical plant, a military wastewater treatment plant, a municipal water treatment plant, a food processing wastewater treatment system, an aerospace water treatment system, and a hotel wastewater recycling system.

3. (canceled)

4. The system of claim 1, wherein the surfactant comprises a detergent.

5. (canceled)

6. The system of claim 1, wherein the filtration unit further comprises a solids filter positioned in the housing upstream of the filtration media, and an ion exchange filter positioned in the housing downstream of the filtration media.

7. (canceled)

8. Wastewater filtration media, comprising:
an oleophilic foam substrate comprising an oleophilic polymer; and
a hydrophobic coating on the oleophilic foam substrate.

9. The filtration media of claim 8, wherein the oleophilic foam substrate has an average pore size between 400 μm and 1000 μm.

10. (canceled)

11. The filtration media of claim 8, wherein the oleophilic polymer is selected from the group consisting of polyvinylchloride (PVC), polyethylene (PE), polyurethane (PU), polystyrene (PS), polylactic acid (PLA), acrylonitrile butadiene styrene (ABS), polycarbonate (PC), fluorine-based polymer, chlorine-based polymer, silicone, nylon, acrylics, cellulose and composites thereof.

12. The filtration media of claim 8, wherein the oleophilic polymer is PU.

13. The filtration media of claim 8, wherein the oleophilic foam substrate has an oil contact angle between 0° and 90°.

14. The filtration media of claim 13, wherein the oleophilic foam substrate has an oil contact angle between 0° and 10°.

15. The filtration media of claim 8, wherein the oleophilic foam substrate has a critical surface tension of between 20 mN/m and 70 mN/m.

16. The filtration media of claim 15, wherein the oleophilic foam substrate has a critical surface tension of between 20 mN/m and 40 mN/m.

17. The filtration media of claim 8, wherein the hydrophobic coating has a water contact angle between 90° and 180°.

18. The filtration media of claim 8, wherein the hydrophobic coating is selected from the group consisting of halogen-based polymer, polyethylene glycol (PEG), protein lipids, graphene and carbon nanotubes.

19. The filtration media of claim 18 wherein the hydrophobic coating is a fluorine-based polymer.

20. The filtration media of claim 19, wherein the hydrophobic coating comprises polytetrafluoroethylene (PTFE).

21. The filtration media of claim 8, wherein the hydrophobic coating comprises deposited particles having an average diameter of 1 μm, to 5 μm.

22. A method of separating a waste stream comprising water, surfactant, and hydrophobic material, the method comprising:
absorbing a majority of the hydrophobic material onto an oleophilic foam substrate of filtration media, wherein the filtration media comprises a foam substrate comprising an oleophilic polymer and the filtration media further comprises a hydrophobic coating on the oleophilic foam substrate; and
rejecting a majority of the water and surfactant from absorption onto the filtration media to produce a filtrate stream comprising water and surfactant.

23. The method of claim 22, wherein the waste stream comprises greywater from a laundry, dishwashing, carwash, or petrochemical operation.

24. (canceled)

25. The method of claim 22, further comprising mixing the filtrate stream with a source of make-up water to produce a mixture prior to re-use at a point of use.

26-37. (canceled)
